(19) United States
(12) Patent Application Publication
(10) Pub. No.: US 2012/0188196 A1
(43) Pub. Date: Jul. 26, 2012

(54) DISPLAY APPARATUS AND TOUCH PANEL AND METHOD FOR MANUFACTURING THE SAME

(75) Inventors: HSUAN-CHEN LIU, Wugu (TW); Mu-kai Kang, Wugu (TW); Wen-chi Lin, Wugu (TW); Sung-chun Lin, Wugu (TW)

(73) Assignee: HANNSTAR DISPLAY CORPORATION, WUGU (TW)

(21) Appl. No.: 13/078,915

(22) Filed: Apr. 1, 2011

(30) Foreign Application Priority Data
Jan. 26, 2011 (TW) 100102840

(51) Int. Cl. G06F 3/045; H01J 9/00

(52) U.S. Cl. 345/174; 445/24

(57) ABSTRACT

A display apparatus, a touch panel and a method for manufacturing the touch panel are disclosed. The display apparatus comprises a display panel and the touch panel. The method comprises the following steps: forming a first electrode sensing layer on a first substrate; forming an insulating layer on the first sensing electrode layer; forming a second sensing electrode layer on the insulating layer; forming a barrier electrode layer on a second substrate; and forming a liquid crystal layer between the second sensing electrode layer and the barrier electrode layer.

### FIELD OF THE INVENTION

The present invention relates to a display apparatus, a touch panel and a method for manufacturing the same, and more particularly, to a display apparatus, a parallax barrier touch panel having a touch function and a three-dimensional (3D) image displaying function, and a method for manufacturing the same.

### BACKGROUND OF THE INVENTION

Currently, a display apparatus may have multiple functions, such as a displaying function, a touch function, and a 3D image displaying function. In general, a multi-functional display has to have more value added for achieving various functionalities. For example, a touch panel or a parallax barrier panel has to be added in a display for achieving a display apparatus with a touch control function or a 3D image display function.

For example, when integrating the touch function and the 3D image display function into a liquid crystal display (LCD), an LCD panel, the touch panel, and the parallax barrier panel are required for the display.

However, at this time, the above-mentioned display with multi-functions needs 6 glass substrates and three adhesion steps for assembly. Thus, the conventional display with multi-functions is relatively thick in outline dimension and more complicated in assembly.

### SUMMARY OF THE INVENTION

Therefore, an aspect of the present invention is to provide a display apparatus, a touch panel and a method for manufacturing the same for integrating a touch function and a 3D image display function into the touch panel.

According to an embodiment of the present invention, the touch panel comprises a first substrate, a first sensing electrode layer formed on the first substrate, an insulating layer formed on the first sensing electrode layer, a second sensing electrode layer formed on the insulating layer, a second substrate and a barrier electrode layer formed on the second substrate, and a liquid crystal layer formed between the second substrate and the first substrate.

According to another embodiment of the present invention, the display apparatus comprises a display panel and a touch panel. The touch panel comprises a first substrate, a first sensing electrode layer formed on the first substrate, an insulating layer formed on the first sensing electrode layer, a second sensing electrode layer formed on the insulating layer, a second substrate and a barrier electrode layer formed on the second substrate, and a liquid crystal layer formed between the second substrate and the first substrate.

According to yet another embodiment of the present invention, the method for manufacturing a touch panel comprises the following steps: forming a first sensing electrode layer on a first substrate; forming an insulating layer on the first sensing electrode layer; forming a second sensing electrode layer on the insulating layer; forming a barrier electrode layer on a second substrate; and forming a liquid crystal layer between the second sensing electrode layer and the barrier electrode layer.

In one embodiment of the present invention, the second sensing electrode layer includes a plurality of second sensing pads.

In one embodiment of the present invention, the second sensing electrode layer is a common electrode connected to a common voltage.

In one embodiment of the present invention, the first sensing electrode layer and the second sensing electrode layer are formed as a projected capacitive sensing circuit.

In one embodiment of the present invention, the first sensing electrode layer and the second sensing electrode layer are formed as a resistive sensing circuit.

In one embodiment of the present invention, the barrier electrode layer comprises a plurality of parallax barrier electrodes being arranged in a periodical manner, and a predetermined pitch which is between each adjacent two of the parallax barrier electrodes is less than or equal to 300 μm.

In one embodiment of the present invention, the second sensing electrode layer includes a plurality of sensing pads, a pitch which is between each adjacent two of the sensing pads is less than or equal to 50 μm, and the width of each of the sensing pads is less than or equal to 10 mm.

In one embodiment of the present invention, the touch panel is bonded on the display panel by using an optical adhesive.

In one embodiment of the present invention, the display apparatus further comprises a cover lens disposed on the touch panel.

In one embodiment of the present invention, the pitch between the barrier electrodes is greater than the pitch between the sensing pads.

In one embodiment of the present invention, the width of the sensing pad is greater than the pitch between the barrier electrodes.

Therefore, with the use of the touch panel of the display apparatus disclosed in the embodiments of the present invention, the touch function and the 3D image display function can be integrated into the display apparatus for reducing the number of glass substrates being used, and thus the weight, thickness and cost thereof can be reduced. Furthermore, the assembly steps of the display apparatus can be reduced and simplified for reducing the assembly time and labor thereof.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing a display apparatus according to an embodiment of the present invention;

FIG. 2 is a partially cross-section view showing the display apparatus according to an embodiment of the present invention;

FIG. 3A is a schematic diagram showing the first sensing electrode layer according to an embodiment of the present invention;

FIG. 3B is a schematic diagram showing the second sensing electrode layer according to an embodiment of the present invention;

FIG. 3C is a schematic diagram showing the first and the second sensing electrode layer according to an embodiment of the present invention;

FIG. 4 is a schematic diagram showing the barrier electrode layer according to an embodiment of the present invention; and

FIG. 5 is a flow diagram showing a method for manufacturing the touch panel according to an embodiment of the present invention.

### DETAILED DESCRIPTION OF THE PREFERRED EMBODIMENT

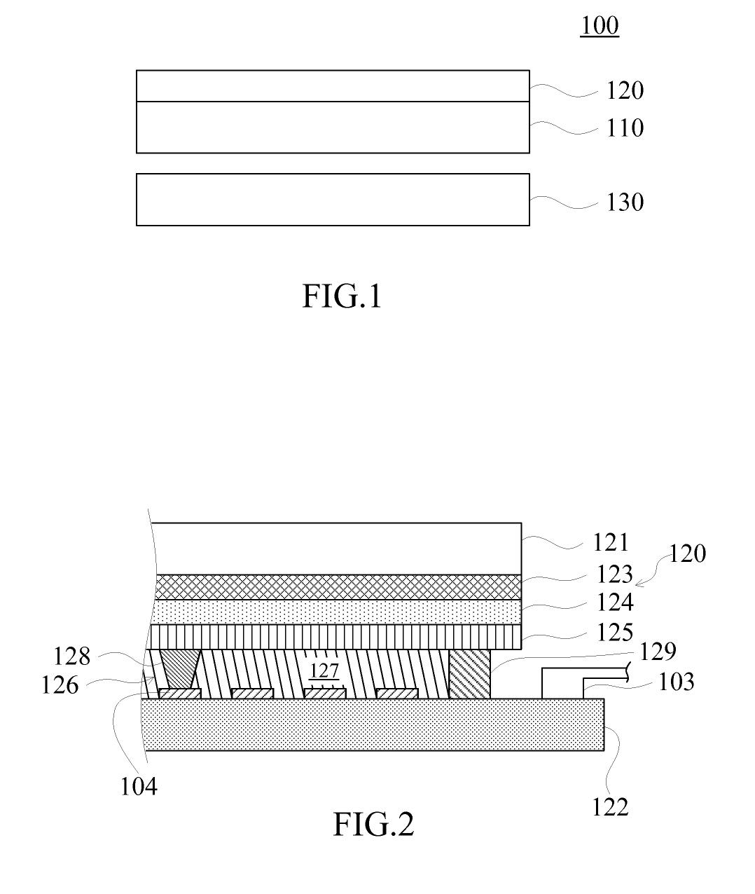

In order to make the illustration of the present invention more explicit and complete, the following description is stated with reference to FIG. 1 through FIG. 4.

In the drawings, like reference numerals indicate like components or items.

Referring to FIG. 1, a schematic diagram showing a display apparatus according to an embodiment of the present invention is illustrated. The display apparatus 100 of the present embodiment can have a touch control function and a 3D image display function at the same time. That is, the display apparatus 100 can sense the touch of a user's fingers or other objects and output corresponding signals, and the display apparatus 100 can also display 3D images. The display apparatus 100 may comprise a display panel 110 and a touch panel 120. The touch panel 120 is disposed on the display panel 110 for displaying the 3D images and sensing the touch of a finger or an object.

Referring to FIG. 1 again, the display panel 110 may be a liquid crystal display (LCD) panel, an organic light emission diode (OLED) panel, a plasma display panel (PDP) or a field emission display (FED) panel for displaying a two-dimensional (2D) image. In the present embodiment, the display panel 110 may be the LCD panel. At this time, the display apparatus 100 may further comprise a backlight module 130 for providing a backlight to the display panel 110 (LCD panel).

Referring to FIG. 1 and FIG. 2, FIG. 2 is a partially cross-section view showing the display apparatus according to an embodiment of the present invention. The touch panel 120 comprises a first substrate 121, a second substrate 122, a first sensing electrode layer 123, an insulating layer 124, a second sensing electrode layer 125, a barrier electrode layer 126, a liquid crystal layer 127, spacers 128 and a sealant 129. The first sensing electrode layer 123, the insulating layer 124 and the second sensing electrode layer 125 are formed on the first substrate 121 in sequence. The barrier electrode layer 126 is formed on the second substrate 122. The liquid crystal layer 127 is formed between the first substrate 121 and the second substrate 122 and sealed by the sealant 129. The spacers 128 are disposed between the first substrate 121 and the second substrate 122 to regulate the cell gap there-between. The spacers 128 may be made of silica, polymer or a resistant material, and in a form of a spherical shape or a column shape.

The first substrate 121 and the second substrate 122 may be glass substrates or a flexible transparent substrate, and the material thereof may be glass, polycarbonate (PC), polyethylene terephthalate (PET), polymethylmethacrylate (PMMA), cyclic olefin copolymer (COC) or polyether sulfone (PES). In the present embodiment, the second substrate 122 is disposed between the first substrate 121 and the display panel 110, and the first substrate 121 is disposed at one side of the display panel 110 opposite to the second substrate 122, and the first substrate 121 preferably has a great mechanical strength to be a protective substrate for protecting the touch panel 120 and the display panel 110 from harm.

In one embodiment, the display apparatus 100 may further comprise a cover lens (not shown) which can be disposed on the touch panel 120 for protecting the touch panel 120. The material of the cover lens is preferably glass or plastics with high mechanical strength, and the cover lens can be adhered to the touch panel by an optical adhesive.

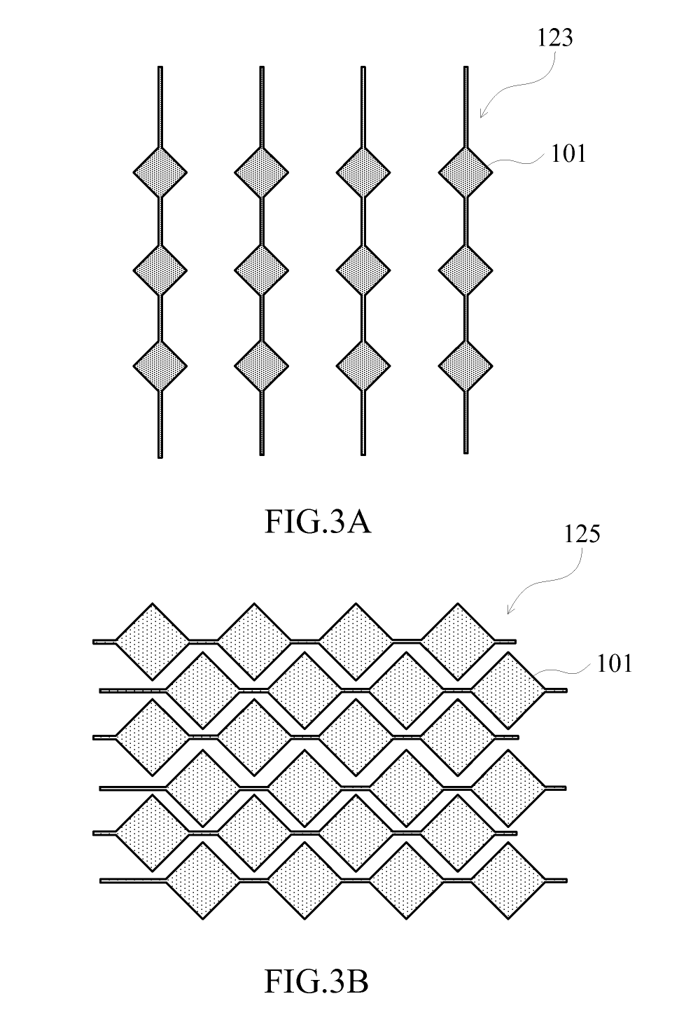

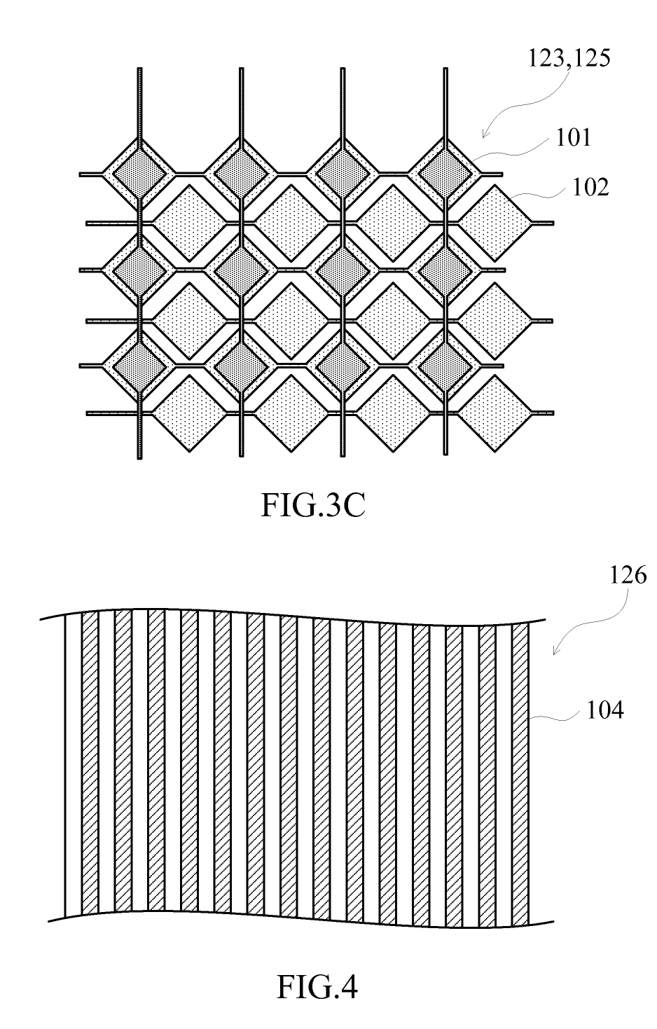

Referring to FIG. 2 through FIG. 3C, FIG. 3A is a schematic diagram showing the first sensing electrode layer according to an embodiment of the present invention, and FIG. 3B is a schematic diagram showing the second sensing electrode layer according to an embodiment of the present invention, and FIG. 3C is a schematic diagram showing the first and the second sensing electrode layer according to an embodiment of the present invention. The first sensing electrode layer 123 and the second sensing electrode layer 125 may be formed as a projected capacitive sensing circuit for sensing the touch or moving of the finger or object. The first sensing electrode layer 123 and the second sensing electrode layer 125 are made of a transparent conductive material, such as ITO, IZO, AZO, ATO, GZO, TCO or ZnO. The first sensing electrode layer 123 may have a plurality of first sensing pads 101, and the second sensing electrode layer 125 may have a plurality of second sensing pads 102. The first sensing pads 101 and the second sensing electrode layer 125 are arranged in a matrix manner for sensing the touch or moving of the object, wherein the shape of the pads 101 and 102 may be rhombus or polygon. The insulating layer 124 may be made of a transparent insulating material which is formed between the first sensing electrode layer 123 and the second sensing electrode layer 125 for electrically isolating the sensing pads 101 and 102 in different directions. For example, the first sensing pads 101 in a first direction can be electrically isolated from the second sensing pads 102 in a second direction (the second direction is different to the first direction, such as vertical to the first direction) by the insulating layer 124. In this case, the second sensing pads 102 are preferably arranged on the insulating layer 124 in a dense manner, wherein a pitch which is between each adjacent two of the second sensing pads 102 is less than or equal to 50 μm, such as 25 μm, the width of each second sensing pads 102 may be less than or equal to 10 mm, such as 5 mm.

In this embodiment, the first sensing electrode layer 123 and the second sensing electrode layer 125 can sense the touch or moving of the object and output sensing signals accordingly. The sensing signals can be transmitted to a circuit board 103 of the second substrate 122 (such as a flexible printed circuit board).

In one embodiment, the first sensing electrode layer 123 and the second sensing electrode layer 125 may be formed as, for example, a resistive sensing circuit. At this time, the insulating layer 124 which is disposed between the first sensing electrode layer 123 and the second sensing electrode layer 125 may include spacing units for separating the electrode layers 123 and 125.

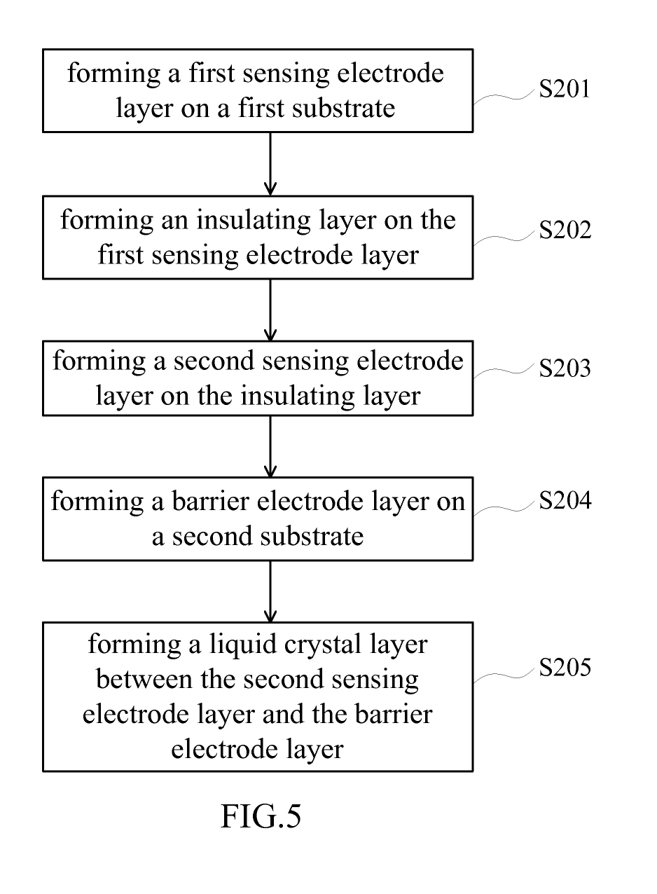

Referring to FIG. 2 and FIG. 4, FIG. 4 is a schematic diagram showing the barrier electrode layer according to an embodiment of the present invention. The barrier electrode layer 126 of the present embodiment is formed on the second substrate 122 for selectively forming parallax barriers to shelter light for forming the 3D image effect. The barrier electrode layer 126 is made of the transparent conductive material, such as ITO, IZO, AZO, ATO, GZO, TCO or ZnO. The barrier electrode layer 126 may comprise a plurality of parallax barrier electrodes 104 for selectively forming the 3D image effect, wherein the pitch between the barrier electrodes 104 of the barrier electrode layer 126 is greater than the pitch between the sensing pads 102 of the second sensing electrode layer 125, and the width of the sensing pad 102 is greater than the pitch between the barrier electrodes 104. The parallax barrier electrodes 104 are preferably arranged in a periodical manner, and there is a predetermined pitch between each adjacent two of the parallax barrier electrodes 104. The predetermined pitch may be less than or equal to 300 μm, such as 100 μm, and the width of each of the parallax barrier electrodes 104 may be less than or equal to 300 μm, such as 100 μm.

The width (about 5 mm) of each of the second sensing pad 102 of the second sensing electrode layer 125 is far greater than the width or the pitch (about 100 μm) of the parallax barrier electrodes 104, and the pitch between the second sensing pads 102 is relatively small compared with the pitch between the barrier electrode. Therefore, in comparison with the parallax barrier electrodes 104 of the barrier electrode layer 126, the second sensing electrode layer 125 can be regarded as a common electrode which is connected to a common voltage. In other words, the second sensing pad 102 is not only used for sensing touch position but also treated as common electrode. Accordingly, when applying a voltage to the second sensing electrode layer 125 and the barrier electrode layer 126, an electric field is formed between the electrode layers 125 and 126 for selectively controlling the liquid crystal molecules of the liquid crystal layer 127 to rotate. By the rotating of the liquid crystal molecules of the liquid crystal layer 127 which is between the electrode layers 125 and the parallax barrier electrodes 104, the touch panel 120 can allow the light to pass or to be sheltered. When the light passes through the liquid crystal layer 127, the user can directly watch the 2D images of the display panel 110. When the light is sheltered by the liquid crystal molecules of the liquid crystal layer 127 which is between the electrode layers 125 and the parallax barrier electrodes 104, the parallax barriers are periodically formed between the electrode layers 125 and the parallax barrier electrodes 104. At this time, the user can respectively see different picture at different positions of the display panel 110, thereby forming a visual effect as if watching a 3D image. Therefore, with the use of the liquid crystal molecules of the liquid crystal layer 127 between the electrode layers 125 and the parallax barrier electrodes 104, and modulate the rotation of the liquid crystal molecules of the liquid crystal layer 127, the parallax barrier touch panel 120 can selectively switch 2D/3D images.

Referring to FIG. 5, a flow diagram showing a method for manufacturing the touch panel according to an embodiment of the present invention is illustrated. When manufacturing the touch panel 120 of the present embodiment, firstly, the first sensing electrode layer 123 is formed on the first substrate 121 (step S201). Subsequently, the insulating layer 124 is formed on the first sensing electrode layer 123 (step S202). Subsequently, the second sensing electrode layer 125 is formed on the insulating layer 124 (step S203). Subsequently, the barrier electrode layer 126 is formed on the second substrate 122 (step S204). Subsequently, the liquid crystal layer 127 is formed between the second sensing electrode layer 125 and the barrier electrode layer 126 (step S205). When the liquid crystal layer 127 is formed between the electrode layer 125 and 126, the liquid crystal layer 127 can be formed by using a vacuum injection method or a one drop filling (ODF) method, and sealed by the sealant 129, thereby achieving the touch panel 120. When assembling the display apparatus 100 of the present embodiment, the touch panel 120 can be bonded on the display panel 110 by using an optical adhesive 140 for sensing the touch or moving of the finger or object and selectively forming the parallax barriers to generate a 3D image effect.

Therefore, the display apparatus 100 of the present embodiment can utilize the touch panel 120 to achieve the touch function and the 3D image display function at the same time. When the display apparatus 100 performs the touch function, the finger or object can touch the first substrate 121 of the touch panel 120, and the touch or moving thereof can be detected by the sensing circuit formed by the sensing electrode layers 123 and 125 for obtaining the touch controlling effect. When the display apparatus 100 performs the 3D image display function, the user's eyes can respectively watch different images by using the parallax barriers formed by the second sensing electrode layer 125 and the barrier electrode layer 126, thereby forming a 3D image effect with depth perception.

As described above, the display apparatus of the present invention can utilize the touch panel to achieve the touch function and the 3D image display function. Since the touch function and the 3D image display function are integrated into the touch panel, the use of the glass in the display apparatus can be reduced for reducing the weight, thickness and cost thereof, and the process steps thereof can be simplify. Furthermore, with the use of the touch panel of the present invention, the assembly steps of the display apparatus can be reduced and simplified, thereby reducing the assembly time and labor thereof.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A touch panel comprising:
a first substrate;
a first sensing electrode layer formed on the first substrate;
an insulating layer formed on the first sensing electrode layer;
a second sensing electrode layer formed on the insulating layer;
a second substrate faced the first substrate;
a barrier electrode layer formed on the second substrate; and
a liquid crystal layer formed between the second substrate and the first substrate.

2. The touch panel as claimed in claim 1, wherein the second sensing electrode layer is a common electrode connected to a common voltage.

3. The touch panel as claimed in claim 1, wherein the first sensing electrode layer and the second sensing electrode layer are formed as a projected capacitive sensing circuit.

4. The touch panel as claimed in claim 1, wherein the barrier electrode layer comprises a plurality of parallax barrier electrodes arranged in a periodical manner and a predetermined pitch between each adjacent two of the parallax barrier electrodes is less than or equal to 300 μm.

5. The touch panel as claimed in claim 1, wherein the second sensing electrode layer includes a plurality of sensing pads, and a pitch between each adjacent two of the sensing pads is less than or equal to 50 μm, and the width of each of the sensing pads is less than or equal to 10 mm.

6. The touch panel as claimed in claim 1, wherein the second sensing electrode layer includes a plurality of sensing pads, and the barrier electrode layer comprises a plurality of parallax barrier electrodes.

7. The touch panel as claimed in claim 6, wherein the pitch between the barrier electrodes is greater than the pitch between the sensing pads.

8. The touch panel as claimed in claim 6, wherein the width of the sensing pad is greater than the pitch between the barrier electrodes.

9. A display apparatus comprising:
a display panel;
a touch panel comprising:
a first substrate;
a first sensing electrode layer formed on the first substrate;
an insulating layer formed on the first sensing electrode layer;
a second sensing electrode layer formed on the insulating layer;
a second substrate faced the first substrate;
a barrier electrode layer formed on the second substrate; and
a liquid crystal layer formed between the second substrate and the first substrate; and
a backlight module.

10. The display apparatus as claimed in claim 9, wherein the touch panel is adhered to the display panel by using an adhesive.

11. The display apparatus as claimed in claim 9, further comprising a cover lens disposed on the touch panel.

12. A method for manufacturing a touch panel comprising the following steps:
forming a first sensing electrode layer on a first substrate;
forming an insulating layer on the first sensing electrode layer;
forming a second sensing electrode layer on the insulating layer;
forming a barrier electrode layer on a second substrate; and
forming a liquid crystal layer between the second sensing electrode layer and the barrier electrode layer.
